(19) United States
(12) Patent Application Publication
(10) Pub. No.: US 2015/0075663 A1
(43) Pub. Date: Mar. 19, 2015

(54) PIPE AND METHOD FOR MANUFACTURING PIPE

(71) Applicant: HITACHI ZOSEN CORPORATION, Osaka (JP)

(72) Inventors: Donghui Ma, Osaka (JP); Jun Okada, Osaka (JP); Satoshi Ashida, Osaka (JP); Shunsuke Kanagawa, Osaka (JP); Kazuya Etou, Osaka (JP); Keita Yanagihara, Osaka (JP); Hiroaki Arai, Osaka (JP)

(21) Appl. No.: 14/387,448

(22) PCT Filed: Mar. 25, 2013
(86) PCT No.: PCT/JP2013/058603

§ 371 Date: Sep. 23, 2014

(30) Foreign Application Priority Data
Mar. 29, 2012 (JP) P2012-075698

(51) Int. Cl. F16L 9/12; B29C 70/32; F16L 15/00

(52) U.S. Cl. CPC F16L 9/121; F16L 15/001; B29C 70/326; B29K 2101/10
USPC 138/109; 138/141; 138/153; 264/311; 156/245

(57) ABSTRACT

A pipe includes a tubular reinforced fiber structure, and a tubular matrix resin pipe main body centered on the central axis, together with a reinforced fiber structure, covering an internal side of the reinforced fiber structure on the central axis side, and an external side. An external end surface of the pipe main body has an inclined surface whose diameter is gradually reduced toward the end face, which connects the pipe main body to another pipe main body, with the main body inclined surface coupled to a substantially tubular-shaped coupling. A portion of the reinforced fiber structure near the main body inclined surface has a plurality of fiber bundles extending in parallel to the central axis. This prevents a shear failure of the fiber bundles of the reinforced fiber structure of the main body inclined surface.

### TECHNICAL FIELD

The present invention relates to a pipe and a method for manufacturing a pipe.

### BACKGROUND ART

Conventionally, when one pipe is connected to another pipe, a joint structure has been used in which a tapered male screw portion that is formed on an external surface of the pipes and a tapered female screw portion that is formed on an internal surface of a substantially tubular-shaped coupling are screwed together (see JP S37-9634B, for example). A pipe that is made from fiber reinforced plastic has also been used conventionally. In the case of such a pipe, an end portion of a pipe main body that is made from fiber reinforced plastic is inserted into a substantially tubular-shaped connection portion having a tapered male screw portion on its external surface so that the connection portion is fixed to the end portion.

Meanwhile, when the external surface of the end portion of the pipe main body is provided with a main body inclined surface whose diameter is gradually reduced toward its end face, and the main body inclined surface is bonded to an opposing inclined surface that is formed on the internal surface of the connection portion, part of reinforced fiber of the fiber reinforced plastic that constitutes the pipe main body is exposed on the main body inclined surface so as to be bonded to the opposing inclined surface of the connection portion. Accordingly, when many pipes are connected to one another via couplings in the vertical direction and a very large tensile load is exerted on each pipe, a shear failure in which part of the reinforced fiber is pulled together with the connection portion and comes out from the pipe main body is likely to occur on the main body inclined surface depending on the structure of the reinforced fiber.

### SUMMARY OF INVENTION

The present invention is directed to a pipe, and it is an object thereof to improve shear strength of a main body inclined surface.

The pipe according to the present invention includes: a reinforced fiber structure that has a tubular shape; and a matrix resin that covers an internal side, which is a central axis side of the reinforced fiber structure, and an external side of the reinforced fiber structure, thereby constituting, together with the reinforced fiber structure, a pipe main body that has a tubular shape centered on the central axis, wherein an external surface of an end portion of the pipe main body has a main body inclined surface whose diameter is gradually reduced toward an end face, when the pipe main body is connected to another pipe main body, the main body inclined surface is coupled to a coupling that has a substantially tubular shape, and the reinforced fiber structure includes: a first portion that is constituted by a plurality of fiber bundles extending in parallel with the central axis or by a woven structure of a plurality of fiber bundles, and that is arranged near the main body inclined surface; and a second portion that has a structure different from the structure of the first portion, and is arranged apart from the main body inclined surface.

According to the present invention, it is possible to improve shear strength of the main body inclined surface.

In a preferable embodiment of the present invention, the reinforced fiber structure includes: an internal layer that is arranged on the central axis side and has a predetermined structure; and an external layer that is arranged on an external side of the internal layer and has a predetermined structure that is different from the predetermined structure of the internal layer, and the first portion is part of the external layer, and the second portion is the internal layer.

In this case, the internal layer has a laminated structure of a plurality of fiber bundles that extend in parallel with the central axis and a plurality of fiber bundles that extend in a circumferential direction centered on the central axis, so that it is possible to improve strength against hoop stress.

In another preferable embodiment of the present invention, the pipe further includes a connection portion that is a member having a substantially tubular shape centered on the central axis, and includes an opposing inclined surface that is to be bonded to the main body inclined surface of the pipe main body on an internal surface of the connection portion, and a tapered male screw portion on an external surface of the connection portion, wherein when the pipe main body is connected to the other pipe main body, the tapered male screw portion is screwed with a tapered female screw portion that is provided on an internal surface of the coupling, and the main body inclined surface is coupled to the coupling via the connection portion. This allows the pipe to be coupled to the coupling in a removable manner.

The pipe is preferably used for pumping crude oil from an oil well.

The present invention is also directed to a method for manufacturing a pipe. The method includes: a) arranging a first reinforced fiber sheet along an internal surface of a mold that has a cylindrical shape, the first reinforced fiber sheet including a plurality of fiber bundles that extend in parallel with a central axis of the mold or being constituted by a woven structure of a plurality of fiber bundles; b) arranging a second reinforced fiber sheet on the central axis side of the first reinforced fiber sheet, the second reinforced fiber sheet having a structure that is different from the structure of the first reinforced fiber sheet; c) supplying a resin into the mold and rotating the mold around the central axis, thereby molding a pipe main body; and d) forming a main body inclined surface whose diameter is gradually reduced toward an end face on an external surface of an end portion of the pipe main body. Accordingly, it is possible to improve shear strength of the main body inclined surface.

The above-described object and other objects, features, embodiments, and advantages are apparent from the following detailed description of the present invention with reference to the accompanied drawings.

### BRIEF DESCRIPTION OF DRAWINGS

FIG. 1 illustrates pipes and a coupling.

FIG. 2 is a cross-sectional view illustrating a pipe and the coupling.

FIG. 3 is a diagram illustrating a structure of reinforced fiber of the pipe.

FIG. 4 illustrates a flow of processing for manufacturing a pipe.

FIG. 5 is a diagram illustrating the processing for manufacturing a pipe.

FIG. 6 is a diagram illustrating the processing for manufacturing a pipe.

FIG. 7 is a diagram illustrating the processing for manufacturing a pipe.

FIG. 8 is a diagram illustrating a structure of reinforced fiber of a pipe in a comparative example.

FIG. 9 is a cross-sectional view illustrating the vicinity of a main body inclined surface of the pipe in the comparative example.

FIG. 10 is a diagram illustrating a structure of reinforced fiber of a pipe in another comparative example.

FIG. 11 is a diagram illustrating a structure of reinforced fiber of a pipe in another embodiment.

FIG. 12 is a diagram illustrating a structure of reinforced fiber of a pipe in another embodiment.

### DESCRIPTION OF EMBODIMENTS

FIG. 1 illustrates pipes 1 according to an embodiment of the present invention, and FIG. 1 specifically illustrates two pipes 1 that are connected to each other by a coupling 5. The pipe 1 and the coupling 5 have tubular shapes with their centers on a central axis J1. The pipes 1 are used for, for example, pumping crude oil from an oil well and, in this case, a number of pipes 1 are connected to each other via the couplings 5 in a vertical direction. The pipes 1 may be used for underground carbon dioxide storage, seawater desalination plants, geothermal electric power plants, and the like.

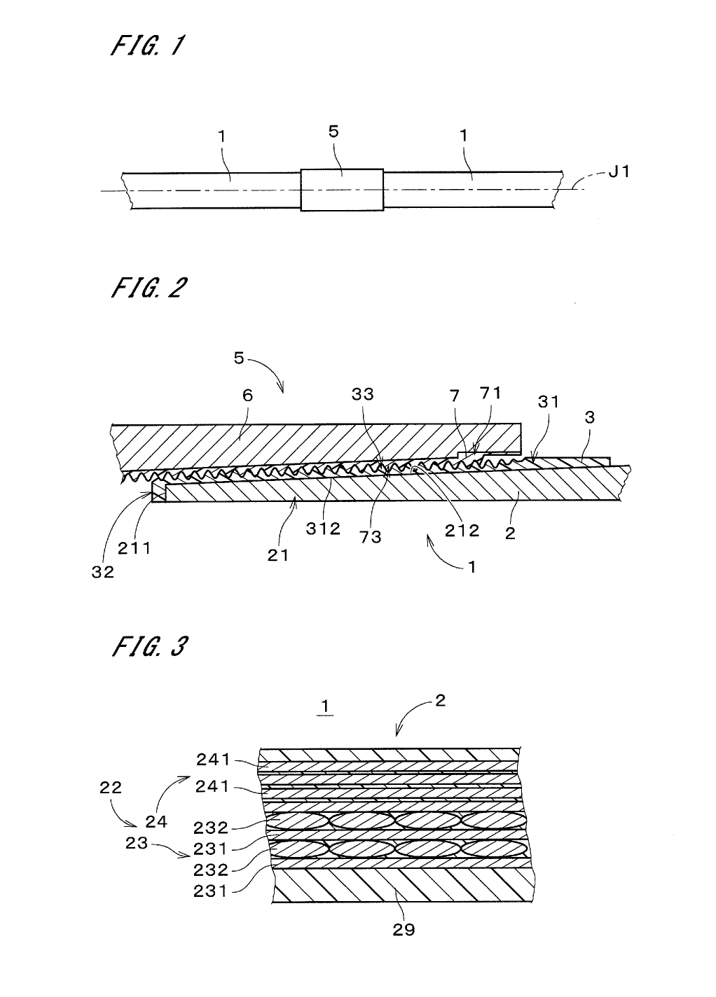

FIG. 2 is a cross-sectional view of the pipe 1 and the coupling 5, and specifically illustrates part of a cross-section that includes the central axis J1 of the pipe 1 and the coupling 5 (the portion that corresponds to the upper side of FIG. 1). The pipe 1 includes a pipe main body 2 that is made from fiber reinforced plastic, and two connection portions 3 that are provided respectively on both end portions of the pipe main body 2 (in FIG. 2, only one connection portion 3 is shown). Since the two connection portions 3 have the same shape, in the following description, attention will be given only to the connection portion 3 that is provided on one end portion 21 of the pipe main body 2. For example, the pipe main body 2 has an internal diameter of 60 millimeters (mm) and an external diameter (excluding the end portion 21) of 77 mm.

The connection portion 3 is a member that is mainly made from a resin, and has a substantially tubular shape centered on the central axis J1 (see FIG. 1). The pipe main body 2 has a tubular shape centered on the central axis J1, and the end portion 21 of the pipe main body 2 is inserted into the connection portion 3 so that the connection portion 3 is fixed to the end portion 21. Reinforced fiber or a matrix resin of the fiber reinforced plastic of the pipe main body 2 may be any of various known materials. Also, a resin from which the connection portion 3 is made may be any of various known materials.

The connection portion 3 includes: a connection portion main body 31 that has a substantially tubular shape; an annular cover portion 32 that covers an end face 211 of the pipe main body 2 at an edge of the connection portion main body 31; and a tapered male screw portion 33 that is formed on an external surface of the connection portion main body 31. An internal surface of the connection portion main body 31 has an inclined surface 312 whose diameter is gradually reduced toward the cover portion 32 (that is, toward the end face 211 of the pipe main body 2). An external surface of the end portion 21 of the pipe main body 2 also has an inclined surface 212 (hereinafter referred to as “main body inclined surface 212”) whose diameter is gradually reduced toward the end face 211, and the inclined surface 312 of the connection portion main body 31 opposes the main body inclined surface 212 of the pipe main body 2 and is bonded to the main body inclined surface 212 (for example, they are bonded together with the matrix resin of the pipe main body 2 or the resin from which the connection portion 3 is made). Hereinafter, the inclined surface 312 of the connection portion main body 31 is referred to as “opposing inclined surface 312”. The external surface of the connection portion main body 31 is also an inclined surface (circular conical surface) whose diameter is gradually reduced toward the cover portion 32, and screw threads are formed along the inclined surface, and thus the tapered male screw portion 33 is formed.

The main body inclined surface 212 of the pipe main body 2 in FIG. 2 is formed by grinding an external surface of an end portion of a tubular-shaped member that is intended to serve as the pipe main body 2, for example. Although reinforced fiber of the fiber reinforced plastic that constitutes the pipe main body 2 is exposed at the end face 211 and the main body inclined surface 212 of the pipe main body 2, in the pipe 1 as has already been described, the end face 211 and the main body inclined surface 212 are respectively covered with the cover portion 32 and the opposing inclined surface 312 of the connection portion 3, thus preventing degradation of the reinforced fiber due to fluid flowing through the pipe 1, exfoliation of the reinforced fiber and the matrix resin, and the like. Note that in a region on an internal surface side of the pipe main body 2, the matrix resin is present with a certain thickness so as to form a corrosion-resistant layer.

FIG. 3 is a diagram illustrating a structure of reinforced fiber of the pipe main body 2. The pipe main body 2 having a tubular shape is provided with a reinforced fiber structure 22 that has a tubular shape. As will be described later, in the present embodiment, the reinforced fiber structure 22 is produced by winding a sheet of reinforced fiber (such as glass fibers) into a tubular shape, and therefore it is conceivable that the reinforced fiber structure 22 is in the state of being wound into a tubular shape. An internal side of the reinforced fiber structure 22 that is on the central axis side J1 and an external side of the reinforced fiber structure 22 (in FIG. 3, the lower side and upper sides, respectively) are covered with matrix resins 29. In other words, the matrix resins 29 constitute the pipe main body 2, together with the reinforced fiber structure 22.

The reinforced fiber structure 22 includes: internal layers 23 that are arranged on the central axis J1 side, and external layers 24 that are arranged on the external side of the internal layers 23. The internal layers 23 have a laminated structure of a plurality of fiber bundles 231, which extend in parallel with the central axis J1 (in the lateral direction in FIG. 3), and a plurality of fiber bundles 232, which extend in a circumferential direction centered on the central axis J1. Specifically, the plurality of fiber bundles 231, each of which extends along the central axis J1, are closely arranged on a plurality of circumferences (on a plurality of virtually substantially tubular surfaces) that have their centers on the central axis J1 and have different radii, so as to form the layers of the fiber bundles 231. Also, the plurality of fiber bundles 232 that have each a substantially ring-shape centered on the central axis J1 and have the same radius along the central axis J1 are closely arranged, so as to form each layer of the fiber bundles 232. In the internal layers 23, the layers of the fiber bundles 231 and the layers of the fiber bundles 232 are alternately laminated in a radial direction that is perpendicular to the central axis J1, and thus the internal layers 23 have a predetermined structure along the central axis J1.

The external layers 24 are constituted only by a plurality of fiber bundles 241, which extend in parallel with the central axis J1. Specifically, the plurality of fiber bundles 241, each of which extends along the central axis J1, are closely arranged on a plurality of circumferences that have their centers on the central axis J1 and have different radii, and the layers of the fiber bundle 241 are laminated in the radial direction. In this manner, the external layers 24 have, along the central axis J1, a predetermined structure that is different from that of the internal layers 23.

In the pipe main body 2, the above-described main body inclined surface 212 is formed on the outer side in the radial direction of the external layers 24, and the internal layers 23 are arranged only at the location in the radial direction where the end face 211 is present. Thus, on the main body inclined surface 212, only the external layers 24 of the reinforced fiber structure 22 are exposed and the internal layers 23 located apart from the main body inclined surface 212 in the radial direction are not exposed on the main body inclined surface 212.

The coupling 5 in FIG. 2 includes a coupling main body 6 made from fiber reinforced plastic, and a connection portion 7 that is a member made from a resin and has a substantially tubular shape centered on the central axis J1 (see FIG. 1). The connection portion 7 is provided on an internal surface of the coupling main body 6 that has a substantially tubular shape centered on the central axis J1. The connection portion 7 includes a connection portion main body 71 that has a substantially tubular shape, and a tapered female screw portion 73 is formed on an internal surface of each end portion of the connection portion main body 71 in the direction of the central axis J1 (in the lateral direction in FIG. 2). Reinforced fiber and a matrix resin of fiber reinforced plastic of the coupling main body 6 may be any of various known materials. Also, the resin from which the connection portion 7 is made may also be any of various known materials.

When connecting one pipe 1 to another pipe 1, that is, when connecting one pipe main body 2 to another pipe main body 2, a tapered male screw portion 33 at one end portion 21 of one pipe main body 2 is screwed with one tapered female screw portion 73 that is provided on the internal surface of the coupling 5, and a tapered male screw portion 33 at one end portion 21 of the other pipe main body 2 is screwed with the other tapered female screw portion 73 of the coupling 5. In other words, at each end portion 21 of the pipe main bodies 2, the main body inclined surface 212 is coupled to the substantially tubular-shaped coupling 5 via the connection portions 3 and 7. Note that the tapered male screw portion 33 is tightened with respect to the tapered female screw portion 73 in a relative manner, and either one of the pipe 1 and the coupling 5 may be rotated.

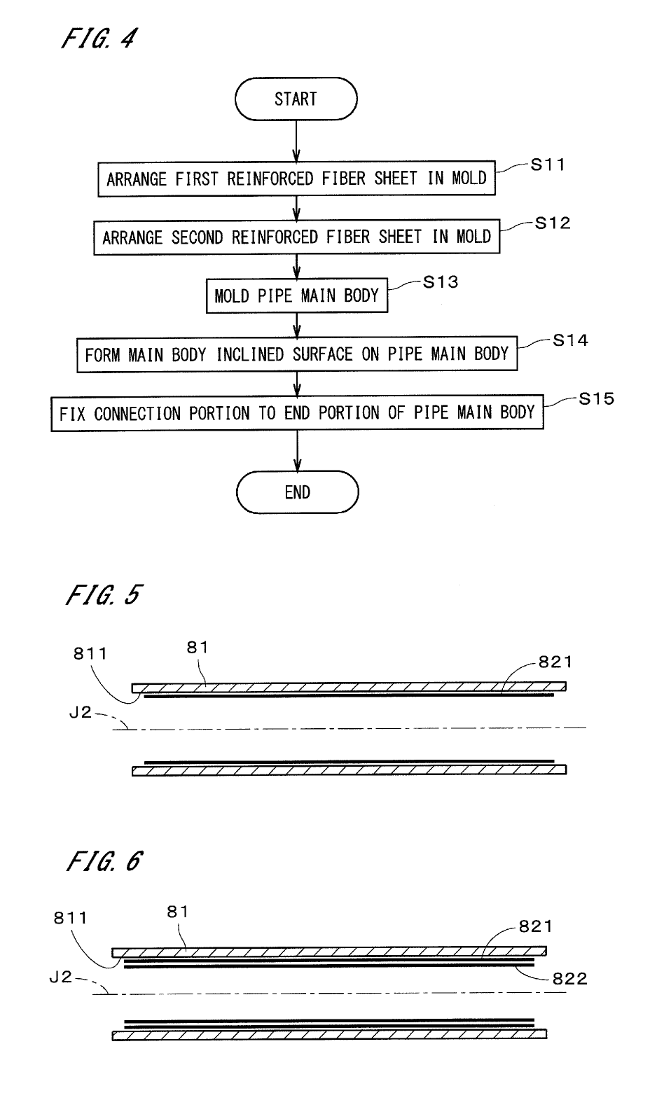

Next, processing for manufacturing the pipe 1 will be described with reference to FIG. 4. In the processing for manufacturing the pipe 1, first, as illustrated in FIG. 5, a mold 81 that has a cylindrical shape is prepared, and a first reinforced fiber sheet 821 is arranged along an internal surface 811 of the mold 81 (step S11). The first reinforced fiber sheet 821 is a sheet that includes, as main reinforced fiber, a plurality of fiber bundles that extend in parallel with a central axis J2 of the mold 81 (see the external layers 24 in FIG. 3). Note that the first reinforced fiber sheet 821 may partially be provided with other fiber bundles, an adhesive, or the like for maintaining the plurality of fiber bundles in a sheet-shape. In FIG. 5, although the first reinforced fiber sheet 821 is indicated by one solid line, the first reinforced fiber sheet 821 may be wound twice or threefold or more. Note, however, that the first reinforced fiber sheet 821 may preferably be arranged with substantially the same thickness on the entire circumference having its center at the central axis J2. Such a modification applies also to a second reinforced fiber sheet 822 that will be described below.

Next, as illustrated in FIG. 6, the second reinforced fiber sheet 822 is arranged on the central axis J2 side of the first reinforced fiber sheet 821, the second reinforced fiber sheet 822 including reinforced fiber having a structure that is different from that of the first reinforced fiber sheet 821 (step S12). Specifically, the second reinforced fiber sheet 822 has a laminated structure in which the plurality of fiber bundles 231, which extend in parallel with the central axis J2, and the plurality of fiber bundles 232, which extend in the circumferential direction centered on the central axis J2, are alternately laminated in a radial direction that is perpendicular to the central axis J2 (see the internal layers 23 in FIG. 3).

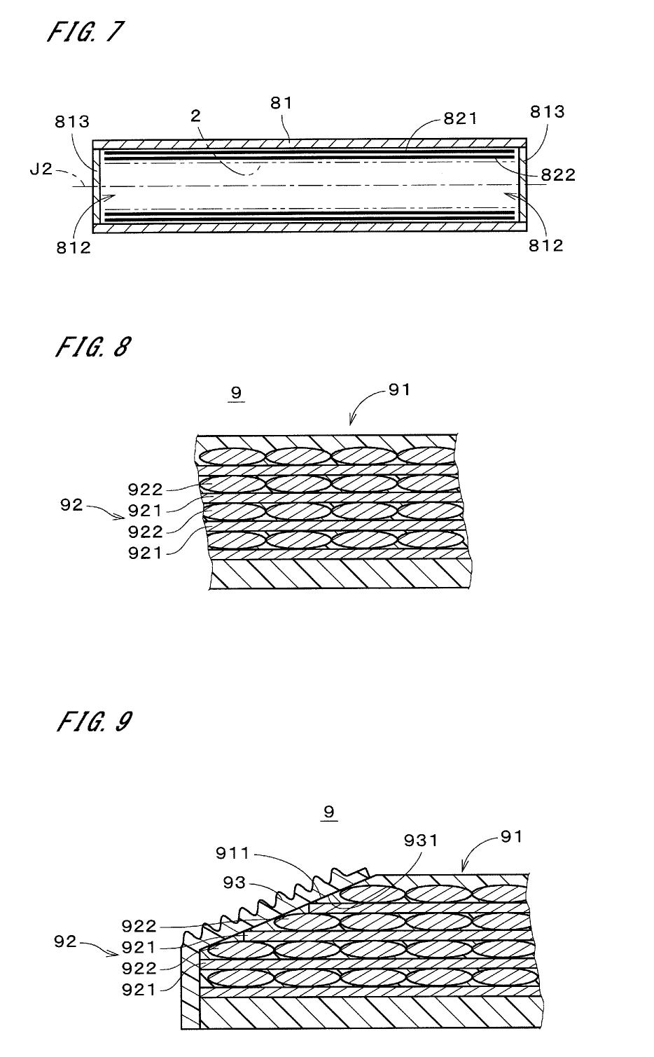

When the first reinforced fiber sheet 821 and the second reinforced fiber sheet 822 have been arranged in the mold 81, closing members 813 are mounted in openings 812 at both end portions of the mold 81 in the direction of the central axis J2, and the openings 812 are closed, as illustrated in FIG. 7. The mold 81 is installed in a centrifugal molding device, and a liquid resin is supplied into the mold 81 from a material supplying portion. At this time, the resin is supplied into the mold 81 through a supply port (not shown) that is provided in the closing member 813. Centrifugal molding is performed by rotating the mold 81 around the central axis J2. In the above-described manner, by supplying a resin into the mold 81, and rotating the mold 81 around the central axis J2, the pipe main body 2 (indicated by chain double-dashed lines in FIG. 7) is molded (step S13). Note that when a thermo-setting resin is used, the mold 81 is heated in the centrifugal molding device.

When the centrifugal molding has been completed, the closing member 813 is removed from one opening 812 of the mold 81, and the pipe main body 2 is pulled out from this opening 812. Then, on each external surface at both end portions 21 of the pipe main body 2, the main body inclined surface 212 (see FIG. 2) whose diameter is gradually reduced toward the end face 211 of the end portion 21 is formed by a tapering process such as grinding (step S14). Note that the main body inclined surfaces 212 may be formed on both end portions after the pipe main body 2 formed by the processing in step S13 has been cut into a piece with a desired length.

Meanwhile, the connection portion 3 (see FIG. 2), which includes the opposing inclined surface 312 on its internal surface and the tapered male screw portion 33 on its external surface, has been prepared in advance, and end portions 21 of the pipe main body 2 are inserted into the connection portion 3, with the main body inclined surfaces 212 at both end portions 21 coated with a liquid resin. The main body inclined surface 212 and the opposing inclined surface 312 of the connection portion 3 are bonded together by hardening (for example, thermally hardening) the resin, and the connection portion 3 is fixed to the end portion 21 of the pipe main body 2 (step S15). With these procedures, the pipe 1 in FIG. 2 is completed.

FIG. 8 is a diagram illustrating a structure of reinforced fiber of a pipe main body 91 of a pipe 9 of a comparative example. In the pipe 9 of the comparative example, an entire reinforced fiber structure 92 has a laminated structure in which a plurality of fiber bundles 921, which extend in parallel with a central axis J1 (in the lateral direction in FIG. 8), and a plurality of fiber bundles 922, which extend in a circumferential direction, are alternately laminated in a radial direction. As illustrated in FIG. 9, thus, near a main body inclined surface 911, both types of the plurality of fiber bundles 921, which extend in parallel with the central axis J1, and the plurality of fiber bundles 922, which extend in the circumferential direction, are exposed and fixed to an opposing inclined surface 931 of a connection portion 93.

When pipes are used in oil wells or the like, many pipes are connected to each other via couplings in the vertical direction, and therefore a very large tensile load is exerted on each pipe. At this time, a shear failure in which the fiber bundles 922 (that is, the fiber bundles 922, which extend in a circumferential direction) that are fixed to the opposing inclined surface 931 of the connection portion 93 are pulled together with the connection portion 93 and come out from the pipe main body 91 (that is, a shear failure causing offset between layers in the radial direction of the reinforced fiber structure 92) may occur on the main body inclined surface 911.

In contrast, in the pipe main body 2 in FIG. 3, the portion of the reinforced fiber structure 22 that is arranged near the main body inclined surface 212 is constituted by the plurality of fiber bundles 241, which extend in parallel with the central axis J1. This prevents such a shear failure, in which the fiber bundles of the reinforced fiber structure 22 are pulled together with the connection portion 3 and come out from the pipe main body 2, from occurring on the main body inclined surface 212, achieving an improvement in the shear strength (that is, the limit strength that withstands shear) of the main body inclined surface 212.

FIG. 10 is a diagram illustrating a structure of reinforced fiber of a pipe main body 91a of a pipe 9a of another comparative example. In the pipe 9a of this comparative example, an entire reinforced fiber structure 92a has a plain woven structure (a plain woven glass cross is used here) in which a plurality of fiber bundles 921a, which extend along the direction of the central axis J1 (in the lateral direction in FIG. 10), and a plurality of fiber bundles 922a, which extend along a circumferential direction, are plain woven. In the pipe 9a of the comparative example shown in FIG. 10, even if the fiber bundles 922a, which extend along the circumferential direction, are pulled together with the connection portion 93 on the main body inclined surface 911 (see FIG. 9), the fiber bundles 922a are prevented from coming out from the pipe main body 91a since the fiber bundles 922a are woven with the plurality of fiber bundles 921a, which extend along the central axis J1.

On the other hand, when a tensile load is being exerted, there may be the case where screw threads of a tapered male screw portion that is provided on one end of the pipe are pressed toward an end face side of the pipe main body by screw threads of a tapered female screw portion of the coupling, so that a force that is directed toward the central axis side of the pipe acts at the edge of the pipe. As a result, the entire circumference of the edge of the pipe is bent toward the central axis side and compression stress (that is, hoop stress) occurs in the circumferential direction of the pipe, causing deformation (buckling in the circumferential direction) or breakage at the edge of the pipe. In the pipe 9a of the comparative example shown in FIG. 10, waves (they are in a wave-shape, and may be referred to as “crimps”) have occurred in the plurality of fiber bundles 922a, which extend along the circumferential direction, resulting in a reduction in the compressive strength against hoop stress. Waves also have occurred in the fiber bundles 921a, which extend along the central axis J1, resulting in a reduction in the tensile strength of the pipe main body 91a. Note that in a common filament winding method, in which reinforced fiber is wound around a mandrel and molded, the fiber bundles cannot be arranged in parallel with the circumferential direction, so that the compressive strength against the hoop stress is lowered, similarly to the pipe 9a of the comparative example.

In contrast, in the pipe 1 in FIG. 3, since the internal layers 23 have layers of the plurality of fiber bundles 232, which extend (without waving) in a circumferential direction centered on the central axis J1, the strength against hoop stress can be improved, relative to that of the pipe 9a in the comparative example. As described above, in the reinforced fiber structure 22, the external layers 24 are made from a reinforced base material that has a structure with a high shear strength, and the internal layers 23 are made from a reinforced base material that has a structure with a high compressive strength, so that an improvement in the tensile strength of the pipe 1 is achieved.

Actually, when tensile tests were performed on two pipes connected via a coupling (see FIG. 1), the results show that a tensile breaking force (tensile strength) was 170 kilonewton (kN) in the case where the pipes 9 of the comparative example in FIG. 8 were used as the two pipes, and a tensile breaking force was 150 kilonewton in the case where the pipes 9a of the comparative example in FIG. 10 were used as the two pipes. In contrast, a tensile breaking force was 210 kilonewton in the case where the pipes 1 of FIG. 3 were used, and it is ascertained that the tensile strength of the pipes 1 is higher than the pipes 9 and 9a of the comparative examples. Note that in the pipe 9a of the comparative example shown in FIG. 10, buckling breakage occurred at the edge of the pipe, but no buckling breakage occurred in the pipe 9 of the comparative example in FIG. 8 and in the pipes 1 in FIG. 2.

Note that in a sheet winding method, in which a prepreg sheet (that is, a sheet formed by impregnating reinforced fiber with a resin) is wound around a mandrel and molded, it is possible to align the fiber bundles in a desired direction but molding of an elongated pipe main body is not easy. Also, since a relatively expensive prepreg sheet is used, the manufacturing cost of the pipes is also increased. In contrast, as described above, in molding of a pipe main body using centrifugal molding, it is possible to produce an elongated pipe main body easily and at a lower cost.

FIG. 11 is a diagram illustrating a structure of reinforced fiber of a pipe main body 2a of a pipe 1a according to another embodiment of the present invention. Similarly to the internal layers 23 in FIG. 3, internal layers 23 of a reinforced fiber structure 22a in FIG. 11 have a laminated structure in which a plurality of fiber bundles 231, which extend in parallel with a central axis J1 (in the lateral direction in FIG. 11), and a plurality of fiber bundles 232, which extend in a circumferential direction centered on the central axis J1, are alternately laminated in a radial direction that is perpendicular to the central axis J1. On the other hand, external layers 24a have a plain woven structure (a plain woven glass cross is used here) in which a plurality of fiber bundles 241a, which extend along the direction of the central axis J1, and a plurality of fiber bundles 242a, which extend along the circumferential direction, are plain woven. In the manufacturing of the pipe 1a in FIG. 11, similar procedures as those in the manufacturing of the pipe 1 in FIG. 2 are performed, except that a sheet that is constituted by the woven structure of the plurality of fiber bundles, as with the external layer 24a, is used as a first reinforced fiber sheet.

In the pipe 1a in FIG. 11, the portion of the reinforced fiber structure 22a that is arranged near the main body inclined surface 212 (see FIG. 2) is constituted by the woven structure of the plurality of fiber bundles 241a and the plurality of 242a. This prevents a shear failure, in which the fiber bundles 242a, which extend along the circumferential direction, of the reinforced fiber structure 22a are pulled together with the connection portion 3 and come out from the pipe main body 2a, from occurring on the main body inclined surface 212, achieving an improvement in the shear strength against the tensile load. Also, by the internal layers 23 including the plurality of fiber bundles 232, which extend the circumferential direction, an improvement in the strength against the hoop stress can be achieved.

When a tensile test was performed on the pipes 1a in FIG. 11, similar to those on the respective pipes 1, 9, and 9a in FIGS. 3, 8, and 10, the results show that a tensile breaking force was 195 kilonewton, and it is ascertained that the tensile strength is higher than those of the pipes 9 and 9a in the comparative examples. No buckling breakage occurred. Note that, in view of preventing the fiber bundles from coming out from the main body inclined surface 212, the plurality of fiber bundles 241a, which constitute the plain woven structure, of the external layers 24a may extend in a direction that is inclined with respect to the central axis J1, and also the plurality of fiber bundles 242a may extend in a direction that is inclined with respect to the circumferential direction on the cylindrical surface centered on the central axis J1. Also, woven structures other than the plain woven structure may be applied to the external layer 24a.

Although the embodiments of the present invention have been described, the present invention is not limited to the above-described embodiments, and various modifications are possible.

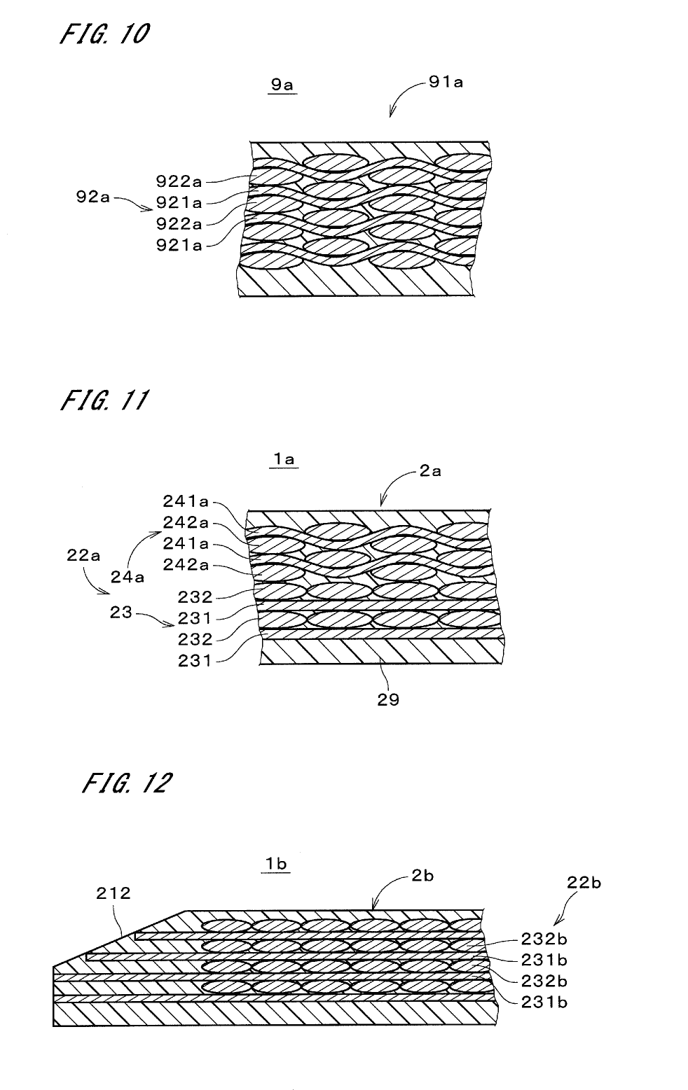

In the above-described embodiments, the reinforced fiber structures 22 and 22a are respectively provided with the internal layers 23 and the external layers 24 and 24a whose structures differ from each other but it is also possible, as illustrated in, for example, FIG. 12, that a portion of the reinforced fiber structure 22b of the pipe main body 2b that is arranged near the main body inclined surface 212 is constituted by the plurality of fiber bundles 231b, which extend in parallel with a central axis J1 (in the lateral direction in FIG. 12), and a portion of the reinforced fiber structure 22b that is located apart from the main body inclined surface 212 in the direction of the central axis J1 has a laminated structure in which the plurality of fiber bundles 231b, which extend in parallel with the central axis J1, and the plurality of fiber bundles 232b, which extend in the circumferential direction, are alternately laminated in the radial direction. Also in the case of a pipe 1b in FIG. 12, it is possible to improve the shear strength of the main body inclined surface 212. Note that in FIG. 12, illustration of the connection portion 3 is omitted. It is also possible that the structure illustrated in FIG. 12 is applied only to the external layers of the reinforced fiber structure 22, and another structure (for example, a laminated structure in which a plurality of fiber bundles that extend in parallel with the central axis J1 and a plurality of fiber bundles that extend in the circumferential direction are alternately laminated in the radial direction) is applied to the internal layers.

As has been described above, the reinforced fiber structure includes: a first portion that is constituted by a plurality of fiber bundles that extend in parallel with the central axis J1 or by a woven structure of a plurality of fiber bundles, and that is arranged near the main body inclined surface 212; and a second portion that has a structure that is different from that of the first portion, and is arranged at a position that is located apart from the main body inclined surface 212 in the direction of the central axis J1 or the radial direction, so that it is possible to ensure the performance that is desired for the pipe main body 2 using the second portion, while improving the shear strength of the main body inclined surface 212. In the examples in FIGS. 3 and 11, the first portion is part of the external layers 24, 24a and the second portion is the internal layers 23.

In view of the improvement in the strength against hoop stress, the internal layers 23 of the reinforced fiber structure 22 may be constituted only by a plurality of fiber bundles, which extend in the circumferential direction.

Although in the above-describe embodiments, by the pipes 1, 1a, and 1b including the connection portion 3, the pipes 1, 1a, and 1b can be connected to the coupling 5 in a removable manner, the connection portion 3 may be omitted in the pipe depending on design of the pipe, and the main body inclined surface 212 of the pipe main body and the internal surface of the coupling 5 may be bonded together (that is, they can be directly connected to each other). Even in this case, it is possible to improve the shear strength of the main body inclined surface 212 by constituting the first portion that is arranged near the main body inclined surface 212 by a plurality of fiber bundles that extend in parallel with the central axis J1 or providing a reinforced fiber structure that has a woven structure of a plurality of fiber bundles.

Although the pipes 1, 1a, and 1b are particularly suitable for use in a circumstance at elevated pressure and temperature in which a high corrosion resistance property is required, as in the case of use for pumping crude oil from an oil well, the pipes 1, 1a, and 1b may, of course, be used in other circumstances than the above-described circumstance.

The configurations of the above-described embodiments and the various modifications may suitably be combined with each other, as long as they are mutually consistent.

Although the present invention has been described in detail, the descriptions having already been made are illustrative and not limiting. Therefore, it can be said that many modifications and modes are possible without departing from the scope of the present invention.

### REFERENCE SIGNS LIST

1, 1a, 1b Pipe
2, 2a, 2b Pipe main body
3 Connection portion
5 Coupling
21 End portion
22, 22a, 22b Reinforced fiber structure
23 Internal layer
24, 24a External layer
29 Matrix resin
33 Tapered male screw portion
73 Tapered female screw portion
81 Mold
211 End face
212 Main body inclined surface
231, 232, 241, 231b, 232b, 241a, 242a Fiber bundle
312 Opposing inclined surface
811 Internal surface
821 First reinforced fiber sheet
822 Second reinforced fiber sheet
J1 Central axis (of pipe)
J2 Central axis (of mold)
S11 to S15 Step

1. A pipe comprising:
a reinforced fiber structure that has a tubular shape; and
a matrix resin that covers an internal side, which is a central axis side of the reinforced fiber structure, and an external side of the reinforced fiber structure, thereby constituting, together with the reinforced fiber structure, a pipe main body that has a tubular shape centered on the central axis,
wherein an external surface of an end portion of the pipe main body has a main body inclined surface whose diameter is gradually reduced toward an end face,
when the pipe main body is connected to another pipe main body, the main body inclined surface is coupled to a coupling that has a substantially tubular shape, and
the reinforced fiber structure includes:
a first portion that is constituted by a plurality of fiber bundles extending in parallel with the central axis or by a woven structure of a plurality of fiber bundles, and that is arranged near the main body inclined surface; and
a second portion that has a structure different from the structure of the first portion, and is arranged apart from the main body inclined surface.

2. The pipe according to claim 1,
wherein the reinforced fiber structure includes: an internal layer that is arranged on the central axis side and has a predetermined structure; and an external layer that is arranged on an external side of the internal layer and has a predetermined structure that is different from the predetermined structure of the internal layer, and
the first portion is part of the external layer, and the second portion is the internal layer.

3. The pipe according to claim 2,
wherein the internal layer has a laminated structure of a plurality of fiber bundles that extend in parallel with the central axis and a plurality of fiber bundles that extend in a circumferential direction centered on the central axis.

4. The pipe according to claim 1, further comprising a connection portion that is a member having a substantially tubular shape centered on the central axis, and includes an opposing inclined surface that is to be bonded to the main body inclined surface of the pipe main body on an internal surface of the connection portion, and a tapered male screw portion on an external surface of the connection portion,
wherein when the pipe main body is connected to the other pipe main body, the tapered male screw portion is screwed with a tapered female screw portion that is provided on an internal surface of the coupling, and the main body inclined surface is coupled to the coupling via the connection portion.

5. The pipe according to claim 1, used for pumping crude oil from an oil well.

6. A method for manufacturing a pipe, comprising the steps of:
a) arranging a first reinforced fiber sheet along an internal surface of a mold that has a cylindrical shape, the first reinforced fiber sheet including a plurality of fiber bundles that extend in parallel with a central axis of the mold or being constituted by a woven structure of a plurality of fiber bundles;
b) arranging a second reinforced fiber sheet on the central axis side of the first reinforced fiber sheet, the second reinforced fiber sheet having a structure that is different from the structure of the first reinforced fiber sheet;
c) supplying a resin into the mold and rotating the mold around the central axis, thereby molding a pipe main body; and
d) forming a main body inclined surface whose diameter is gradually reduced toward an end face on an external surface of an end portion of the pipe main body.

7. The method for manufacturing a pipe according to claim 6,
wherein the second reinforced fiber sheet has a laminated structure of a plurality of fiber bundles that extend in parallel with the central axis and a plurality of fiber bundles that extend in a circumferential direction centered on the central axis.

8. The method for manufacturing a pipe according to claim 6, further comprising the step of:
bonding an opposing inclined surface of a connection portion to the main body inclined surface of the pipe main body, the connection portion being a member that has a substantially tubular shape centered on the central axis, and including the opposing inclined surface on an internal surface of the connection portion and a tapered male screw portion on an external surface of the connection portion,
wherein when the pipe main body is connected to another pipe main body, the tapered male screw portion is screwed with a tapered female screw portion that is provided on an internal surface of a coupling, and the main body inclined surface is coupled to the coupling via the connection portion.

9. The method for manufacturing a pipe according to claim 7, further comprising the step of:
bonding an opposing inclined surface of a connection portion to the main body inclined surface of the pipe main body, the connection portion being a member that has a substantially tubular shape centered on the central axis, and including the opposing inclined surface on an internal surface of the connection portion and a tapered male screw portion on an external surface of the connection portion,
wherein when the pipe main body is connected to another pipe main body, the tapered male screw portion is screwed with a tapered female screw portion that is provided on an internal surface of a coupling, and the main body inclined surface is coupled to the coupling via the connection portion.

10. The pipe according to claim 2, further comprising a connection portion that is a member having a substantially tubular shape centered on the central axis, and includes an opposing inclined surface that is to be bonded to the main body inclined surface of the pipe main body on an internal surface of the connection portion, and a tapered male screw portion on an external surface of the connection portion,
wherein when the pipe main body is connected to the other pipe main body, the tapered male screw portion is screwed with a tapered female screw portion that is provided on an internal surface of the coupling, and the main body inclined surface is coupled to the coupling via the connection portion.

11. The pipe according to claim 3, further comprising a connection portion that is a member having a substantially tubular shape centered on the central axis, and includes an opposing inclined surface that is to be bonded to the main body inclined surface of the pipe main body on an internal surface of the connection portion, and a tapered male screw portion on an external surface of the connection portion,
wherein when the pipe main body is connected to the other pipe main body, the tapered male screw portion is screwed with a tapered female screw portion that is provided on an internal surface of the coupling, and the main body inclined surface is coupled to the coupling via the connection portion.

12. The pipe according to claim 2, used for pumping crude oil from an oil well.

13. The pipe according to claim 3, used for pumping crude oil from an oil well.

14. The pipe according to claim 4, used for pumping crude oil from an oil well.

15. The pipe according to claim 10, used for pumping crude oil from an oil well.

16. The pipe according to claim 11, used for pumping crude oil from an oil well.
